(19) United States
(12) Patent Application Publication
(10) Pub. No.: US 2025/0227593 A1
(43) Pub. Date: Jul. 10, 2025

(54) METHOD AND APPARATUS FOR DAPS FAILURE HANDLING

(71) Applicant: LENOVO (BEIJING) LIMITED, Beijing (CN)

(72) Inventors: Min Xu, Beijing (CN); Lianhai Wu, Beijing (CN); Ran Yue, Beijing (CN); Jing Han, Beijing (CN); Jie Hu, Beijing (CN)

(21) Appl. No.: 18/853,284

(22) PCT Filed: Apr. 2, 2022
(86) PCT No.: PCT/CN2022/085028

§ 371 Date: Oct. 1, 2024

(51) Int. Cl. H04W 36/30; H04W 36/00; H04W 56/00; H04W 76/27

(52) U.S. Cl. CPC H04W 36/305; H04W 36/0058; H04W 56/006; H04W 76/27

(57) ABSTRACT

Embodiments of the present disclosure relate to methods and apparatuses for DAPS failure handling. According to some embodiments of the disclosure, a UE may: receive, from a first BS, a DAPS handover configuration to switch from a source cell of the first BS to a target cell; and perform a failure handling operation associated with the DAPS handover based on an expiry time of an associated cell, wherein the expiry time of the associated cell includes at least one of a first expiry time of the source cell or a second expiry time of the target cell.

### TECHNICAL FIELD

Embodiments of the present disclosure generally relate to wireless communication technology, and more particularly to dual active protocol stack (DAPS) failure handling in a non-terrestrial network (NTN) environment.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Until 3rd generation partnership project (3GPP) Release 15 for handover, a user equipment (UE) typically releases the connection with a source cell before the connection is established with the target cell (also called “hard handover”). As a result, the data transmission is stopped at the source cell before the UE starts to communicate with the target cell. This would cause an interruption which is critical for services that are sensitive to latency or continuity. To overcome the above problem, DAPS is introduced wherein the UE maintains the source cell connection after the reception of a handover command, and only releases the source cell connection after a successful access to the target cell (also called “soft handover”). DAPS can be used to reduce or avoid the service interruption and thus to guarantee service continuity during handover. This requires a UE to simultaneously receive and transmit data at both the source cell and target cell for a short period during the handover procedure.

An NTN refers to a network, or segment of networks, which use radio frequency resources on board a spaceborne vehicle or an airborne vehicle for transmission (e.g., a satellite). For example, the satellite in an NTN can be a geostationary Earth orbiting (GEO) satellite with fixed location to the Earth, or a low Earth orbiting (LEO) satellite orbiting around the Earth.

DAPS may be applied to a wireless communication system with an NTN involved to enhance service continuity. For example, a DAPS procedure may be performed between within an NTN or between an NTN and a terrestrial network (TN). A DAPS failure and a radio link failure (RLF) may occur in a wireless communication system with an NTN involved. There is a need for handling the DAPS failure and the RLF in a wireless communication system with an NTN involved.

### SUMMARY

Some embodiments of the present disclosure provide a user equipment (UE). The UE may include a transceiver, and a processor coupled to the transceiver. The processor may be configured to: receive, from a first base station (BS), a dual active protocol stack (DAPS) handover configuration to switch from a source cell of the first BS to a target cell; and perform a failure handling operation associated with the DAPS handover based on an expiry time of an associated cell, wherein the expiry time of the associated cell includes at least one of a first expiry time of the source cell or a second expiry time of the target cell.

Some embodiments of the present disclosure provide a base station (BS). The BS may include a transceiver, and a processor coupled to the transceiver. The processor may be configured to: determine an expiry time of a cell, wherein the cell is a source cell or a target cell for a dual active protocol stack (DAPS) handover; and transmit the expiry time to a user equipment (UE).

In some embodiments of the present disclosure, the expiry time may be determined based on at least one of: a serving time of the cell; a propagation delay between the UE and a BS that the cell belongs to; or a reference propagation delay in the cell. The serving time of the cell may include at least one of: a stop serving time of the cell; a time when an elevation angle between a radio access network (RAN) node that generates the cell and the UE is smaller than or equal to lower than an elevation angle threshold; or a time when an elevation angle between the RAN node and a reference location of the cell is smaller than or equal to the elevation angle threshold.

In some embodiments of the present disclosure, transmitting the expiry time to the UE may include at least one of: transmitting broadcast information indicating the expiry time; transmitting a signaling message indicating the expiry time to the UE; or transmitting a signaling message indicating the expiry time to the UE via a BS that the source cell belongs.

In some embodiments of the present disclosure, the processor may be further configured to receive a reason for a DAPS handover failure, wherein the reason includes at least one of target cell movement or target cell expiry.

Some embodiments of the present disclosure provide a method for wireless communication performed by a UE. The method may include: receiving, from a first base station (BS), a dual active protocol stack (DAPS) handover configuration to switch from a source cell of the first BS to a target cell; and performing a failure handling operation associated with the DAPS handover based on an expiry time of an associated cell, wherein the expiry time of the associated cell includes at least one of a first expiry time of the source cell or a second expiry time of the target cell.

In some embodiments of the present disclosure, performing the failure handling operation may include at least one of: in response to the first expiry time of the source cell being reached during the DAPS handover, performing at least one of the following: terminating data transmission, signaling transmission, data reception, and signaling reception in the source cell; discarding a radio resource control (RRC) configuration associated with the source cell; releasing a connection to the source cell; declaring a radio link failure (RLF) in the source cell; precluding the source cell in search of a suitable cell in response to a DAPS handover failure or an RLF failure in the target cell; or precluding the source cell in a cell selection or cell reselection when the UE is in an idle state in response to a DAPS handover failure or an RLF failure in the target cell; or in response to the second expiry time of the target cell being reached during the DAPS handover, performing at least one of the following: terminating data transmission, signaling transmission, data reception, and signaling reception in the target cell; discarding an RRC configuration associated with the target cell; terminating a random access to the target cell; declaring a DAPS handover failure; declaring an RLF in the target cell; precluding the target cell in search of a suitable cell in response to an RLF or a connection release in the source cell or in response to a DAPS handover failure; precluding the target cell in a cell selection or cell reselection when the UE is in an idle state in response to an RLF or a connection release in the source cell or in response to a DAPS handover failure; storing a reason for a DAPS handover failure in response to the DAPS handover failure; reporting a reason for a DAPS handover failure to the source cell in response to the DAPS handover failure and a connection established to the source cell; or reporting a reason for a DAPS handover failure to another cell in response to the DAPS handover failure and a connection established to the another cell. The reason for a DAPS handover failure may include at least one of target cell movement or target cell expiry.

In some embodiments of the present disclosure, the expiry time of the associated cell may indicate at least one of: an absolute time; a remaining service time threshold; or a time duration. The method may further include starting a timer based on the time duration in response to the UE determining the time duration or receiving the time duration.

In some embodiments of the present disclosure, the method may further include receiving the expiry time of the associated cell. In some embodiments, receiving the expiry time of the associated cell may include at least one of: receiving broadcast information indicating the first expiry time in the source cell; receiving broadcast information indicating the second expiry time in the target cell; receiving a signaling message indicating the expiry time of the associated cell from the first BS; or receiving a signaling message indicating the second expiry time of the target cell from a second BS that the target cell belongs to via the first BS. In some embodiments, the expiry time of the associated cell may be based on at least one of: a serving time of the associated cell; a propagation delay between the UE and a BS that the associated cell belongs to; or a reference propagation delay in the associated cell.

In some embodiments of the present disclosure, the method may further include determining the expiry time of the associated cell. In some embodiments, the expiry time of the associated cell may be based on at least one of: a serving time of the associated cell; a propagation delay between the UE and a BS that the associated cell belongs to; or a time when the UE determines the expiry time of the associated cell.

In some embodiments of the present disclosure, the serving time of the associated cell may include at least one of: a stop serving time of the associated cell; a time when an elevation angle between a radio access network (RAN) node that generates the associated cell and the UE is smaller than or equal to lower than an elevation angle threshold; or a time when an elevation angle between the RAN node and a reference location of the associated cell is smaller than or equal to the elevation angle threshold.

Some embodiments of the present disclosure provide a method for wireless communication performed by a BS. The method may include: determining an expiry time of a cell, wherein the cell is a source cell or a target cell for a dual active protocol stack (DAPS) handover; and transmitting the expiry time to a user equipment (UE).

In some embodiments of the present disclosure, the expiry time may indicate at least one of: an absolute time; a remaining service time threshold; or a time duration.

In some embodiments of the present disclosure, the expiry time may be determined based on at least one of: a serving time of the cell; a propagation delay between the UE and a BS that the cell belongs to; or a reference propagation delay in the cell. The serving time of the cell may include at least one of: a stop serving time of the cell; a time when an elevation angle between a radio access network (RAN) node that generates the cell and the UE is smaller than or equal to lower than an elevation angle threshold; or a time when an elevation angle between the RAN node and a reference location of the cell is smaller than or equal to the elevation angle threshold.

In some embodiments of the present disclosure, transmitting the expiry time to the UE may include at least one of: transmitting broadcast information indicating the expiry time; transmitting a signaling message indicating the expiry time to the UE; or transmitting a signaling message indicating the expiry time to the UE via a BS that the source cell belongs.

In some embodiments of the present disclosure, the method may further include receiving a reason for a DAPS handover failure, wherein the reason may include at least one of target cell movement or target cell expiry.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure; and

FIG. 4 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

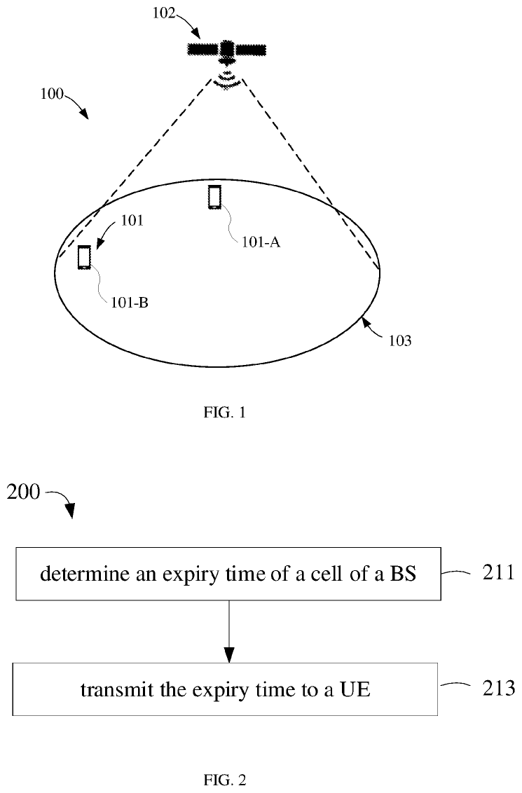

FIG. 1 illustrates a schematic diagram of a wireless communication system 100 in accordance with some embodiments of the present disclosure.

As shown in FIG. 1, wireless communication system 100 may include some UEs 101 (e.g., UE 101-A and UE 101-B) and a radio access network (RAN) node (e.g., satellite 102). Although a specific number of UEs 101 and RAN node is depicted in FIG. 1, it is contemplated that any number of UEs and RAN nodes may be included in wireless communication system 100. In some embodiments, wireless communication system 100 may also include a TN (not shown in FIG. 1).

In some embodiments, satellite 102 may function as a base station (BS) and may include a part or all functions of a BS. In some embodiments, satellite 501 may function as an antenna unit of a BS and the main functionalities of the BS may be located in another entity. For example, a gateway (GW) (not shown in FIG. 1) may function as the BS. Satellite 102 may provide services within a certain area (e.g., area 103), which may be referred to as the coverage area of the BS. In FIG. 1. UE 101-A and UE 101-B are located within area 103.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with a BS (e.g., satellite 102) via uplink (UL) communication signals. The BS (e.g., satellite 102) may communicate with UE(s) 101 via downlink (DL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, satellite 102 (or the associated BS) may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement other protocols including, for example, some other open or proprietary communication protocols. The present disclosure is not intended to be limited to the implementation of any particular wireless communication system architecture or protocol.

DAPS may be applied to a wireless communication system, including for example, a wireless communication system with an NTN involved, such as wireless communication system 100, to enhance service continuity. A DAPS handover failure may occur due to, for example, the wireless channel condition of the target cell. In addition, as during the DAPS handover, where a UE maintains connections to both the source and target cells, an RLF may occur at the source cell or the target cell.

In some embodiments of the present disclosure, to handle these failures, the following principles may apply to the DAPS handover process:
When a DAPS handover fails, the UE falls back to the source cell configuration, resumes the connection with the source cell, and reports the DAPS handover failure via the source cell without triggering radio resource control (RRC) connection reestablishment if the source link is still available. The UE may report the DAPS handover failure using a failure information report procedure.
During a DAPS handover, the UE continues the RLF detection at the source cell until the successful completion of a random access (RA) procedure to the target cell.
For an RLF in the source cell, the UE stops data transmission and reception via the source link and releases the source link, but maintains the source RRC configuration. If a handover failure is then declared at the target cell, the UE selects a suitable cell (e.g., the source cell) and initiates RRC reestablishment, or enters into an idle state (e.g., RRC_IDLE state) if a suitable cell is not found within a certain time.
For an RLF in the target cell before releasing the source cell, the UE selects a suitable cell and initiates RRC reestablishment, or enters into the idle state if a suitable cell is not found within a certain time.

Improvements on the above embodiments for handling the DAPS failure and RLF failure may be required considering certain characteristics of the NTN (e.g., cell movement and relatively long propagation delay).

For example, in an NTN (e.g., an NTN deployed with LEO satellites), channel conditions vary more frequently due to satellite movement. In some scenarios, there may be no significant decadence in cell signal quality before it becomes unavailable. For example, in a quasi-Earth-fixed scenario, the serving duration of a satellite may be restricted by a stop serving time (e.g., provided by t-Service as specified in 3GPP specifications) after which an NTN cell provided by the satellite will vanish. For example, in an Earth-moving scenario, the serving duration of a satellite may be restricted by a minimum serving elevation angle of a satellite antenna.

When applying the DAPS with an NTN cell involved, a DAPS handover failure may occur due to the movement of a neighboring satellite, and an RLF may occur in the source cell or the target cell due to the movement of the serving or neighboring satellite. The above principles when applied to an NTN environment may lead to useless UE failure handling behavior during the DAPS handover, including, for example, a resume connection, reestablishment connection, cell selection, or cell reselection procedure to a cell that will become unavailable due to its movement, and thus may cause unnecessary power consumption and longer service interruption.

Embodiments of the present disclosure provide enhanced solutions for failure handling in a DAPS handover with an NTN involved. The proposed solutions can, for example, reduce UE power consumption upon the failure, reduce service interruption, and accelerate connection (re) establishment after the failure. More details on the embodiments of the present disclosure will be illustrated in the following text in combination with the appended drawings.

When a DAPS handover failure or an RLF occurs in a source NTN cell of a UE when the source cell approaches its service duration limitation (e.g., a stop serving time), the UE may be unable to resume or reestablish the connection to the source cell, and may be unable to report failure information, as well.

For example, for a source NTN cell with a service duration limitation, it may need to handover its serving UE(s) to a target cell before the service at the source cell stops. In this scenario, there could be no sufficient time left allowing a UE to resume or reestablish the connection when the handover fails, considering the large propagation delay for signaling exchange in an NTN. In addition, when an RLF occurs in a source NTN cell when the source cell approaches the service duration limitation, there may be no sufficient time left allowing the UE to recover from the RLF in the source cell (while the target cell may still be possible for recovery). When either of the two failures occurs, the UE would be unable to report the failure information to the source cell.

In some embodiments of the present disclosure, an expiry time of the source cell may be employed for handling the above failures associated with the DAPS handover.

In some embodiments, the expiry time of the source cell may be determined based on at least one of: a serving time of the source cell or a UE to BS propagation delay (e.g., round trip time (RTT)). The serving time of the source cell may be based on at least one of the following: a stop serving time of the source cell (e.g., a quasi-Earth-fixed cell) or the minimum elevation angle of the source cell (e.g., an Earth-moving cell). The stop serving time of the source cell (e.g., t-Service) may be broadcast by the source cell.

The expiry time of the source cell may be determined by the UE, a BS (e.g., source BS), or the network. For example, the source BS may configure the expiry time of the source cell for the UE when, for example, transmitting the DAPS handover configuration or at any other time via any other message.

In some embodiments, the expiry time may indicate at least one of: an absolute time (e.g., a universal time coordinated (UTC) time); a relative time, such as a remaining service time threshold; or a relative time, such as a time duration from being configured or determined. When the expiry time is configured or determined as a time duration, the UE may start a timer based on the expiry time in response to receiving the expiry time, or the UE determines the expiry time.

In response to the expiry time of the source cell being reached, for example, when the current time passes the absolute time, or when the remaining service time of the source cell is equal to or less than the remaining service time threshold, or when the timer expires, the UE may perform a failure handling operation(s) associated with the DAPS handover. For example, the UE may perform at least one of the following: terminating data transmission, signaling transmission, data reception, and signaling reception in the source cell; releasing the source link; discarding the RRC configuration associated with the source cell; or declaring an RLF in the source cell.

When a handover failure or an RLF occurs in the target cell afterwards, the UE may perform at least one of the following failure handling operations: skipping RRC resume or reestablishment to the source cell (as the link is released and configuration is discarded); or selecting a suitable cell and initiating RRC reestablishment; or entering into an idle state when a suitable cell cannot be found within a certain time.

When a DAPS handover fails because a target NTN cell of a UE approaches its service duration limitation (e.g., a stop serving time), the network would not know the reason for such DAPS handover. Embodiments of the present disclosure provide a mechanism for reporting the reason to help the network to facilitate future configurations, for example, avoiding an inappropriate DAPS configuration.

For example, when configuring a target NTN cell for a UE, the remaining service duration of the target cell may differ for UEs in different locations or with different capabilities. For a target NTN cell with a service duration limitation, a DAPS handover failure may occur when a UE does not have sufficient time to complete the random access process, considering the large propagation delay for signaling exchange in an NTN. It would be beneficial if the UE could not only report the DAPS handover failure, but also could report the cause of the handover failure, which may assist the network to avoid such failure in the future.

In some embodiments of the present disclosure, an expiry time of the target cell may be employed for handling the above failure associated with the DAPS handover.

In some embodiments, the expiry time of the target cell may be determined based on at least one of: a serving time of the target cell or a UE to BS propagation delay (e.g., round trip time (RTT)). The serving time of the target cell may be based on at least one of the following: a stop serving time of the target cell (e.g., a quasi-Earth-fixed cell) or the minimum elevation angle of the target cell (e.g., an Earth-moving cell). The stop serving time of the target cell (e.g., t-Service) may be broadcast by the target cell.

The expiry time of the target cell may be determined by the UE, a BS (e.g., target BS), or the network. For example, the source BS may configure the expiry time of the target cell determined by the target BS for the UE when, for example, transmitting the DAPS handover configuration or at any other time via any other message.

In some embodiments, the expiry time may indicate at least one of: an absolute time (e.g., a UTC time); a relative time, such as a remaining service time threshold; or a relative time, such as a time duration from being configured or determined. When the expiry time is configured or determined as a time duration, the UE may start a timer based on the expiry time in response to receiving the expiry time, or the UE determines the expiry time.

In response to the expiry time of the target cell being reached, for example, when the current time passes the absolute time, or when the remaining service time of the target cell is equal to or less than the remaining service time threshold, or when the timer expires, the UE may perform a failure handling operation(s) associated with the DAPS handover before the random access to the target cell completes (e.g., before or during the random access).

For example, the UE may perform at least one of the following: considering the DAPS handover as a failure; declaring a DAPS handover failure; declaring an RLF in the target cell; terminating data transmission, signaling transmission, data reception, and signaling reception in the target cell; terminating the random access to the target cell; discarding an RRC configuration associated with the target cell; reporting the DAPS handover failure; reporting the reason for the DAPS handover failure to the source cell if the source link is resumed or reestablished; storing the reason for the DAPS handover failure; or reporting the reason for the DAPS handover failure to another cell if the source link is not available and the UE connects to the another cell.

In some embodiments, the reason for the DAPS handover failure may include at least one of target cell movement or target cell expiry. In some examples, the UE may use a DAPS failure report procedure to report the reason for the DAPS handover failure. For example, the UE may transmit a failure information message indicating the reason for the DAPS handover failure by, for example, extending an information element (IE) in the message (e.g., FailureInfoDAPS as specified in 3GPP specifications) or a new dedicated IE. In some embodiments, the UE may utilize other procedures to report the reason for the DAPS handover failure. For example, the UE may report the reason in an immediate minimization of drive tests (MDTs) for a self-organized network (SON) purpose. In some embodiments, the UE may store the reason in a logged MDT for a SON purpose.

When a DAPS handover failure or an RLF failure occurs, a UE may select a suitable cell or enter into an idle state, and the source NTN cell or target NTN cell may be selected or reselected (e.g., during the search for a suitable cell or during the cell selection or cell reselection for the idle UE) if the cell approaches its service duration limitation (e.g., a stop serving time), but has not exceeded it. For example, for an RLF in the source cell and a handover failure afterwards, or for an RLF in the target cell before releasing the source cell, the UE may select a suitable cell and initiate RRC reestablishment; or the UE may enter into an idle state if a suitable cell is not found within a certain time. If the above failures occur before a cell (source or target) exceeds its service duration limitation, it is highly possible that the UE may select or reselect this cell. In this scenario, there may be no sufficient time left allowing the UE to reestablish the connection with the source cell or target cell. The UE would have to perform a measurement(s) and reselection again when the service duration limitation is exceeded.

To avoid unnecessary connection reestablishment, the UE may preclude the source cell or target cell that approaches its service duration limitation when in search of a suitable cell or in the cell selection or cell reselection when the UE is in an idle state.

In some embodiments of the present disclosure, an expiry time of an associated cell (e.g., the source cell or target cell) may be employed for handling the above failures associated with the DAPS handover. For example, the expiry time of the source cell and the expiry time of the target cell as described above may be employed.

When a UE tries to find a suitable cell for connection establishment or enters an idle state due to the DAPS handover failure or the RLF during the DAPS handover, the UE may perform a failure handling operation(s) associated with the DAPS handover if the expiry time of the associated cell (e.g., the source cell or target cell) is reached.

For example, when the current time passes the absolute time, or when the remaining service time of the associated cell is equal to or less than the remaining service time threshold, or when the timer expires, the UE may perform at least one of the following: stopping any measurements on the associated cell; precluding the associated cell as a candidate cell for a suitable cell to establish the connection; or precluding the associated cell as a candidate cell for cell selection or reselection.

FIG. 2 illustrates a flow chart of an exemplary procedure 200 for wireless communications in accordance with some embodiments of the present disclosure.

Details described in all of the foregoing embodiments of the present disclosure are applicable for the embodiments shown in FIG. 2. In some examples, the procedure may be performed by a BS, for example, satellite 102 in FIG. 1 or a BS associated with satellite 102.

Referring to FIG. 2, in operation 211, a BS may determine an expiry time of a cell of the BS. In some examples, the cell is a source cell for a DAPS handover, and the BS is the source BS. In some examples, the cell is a target cell for a DAPS handover and the BS is the target BS. The expiry time may represent a timing point before which a UE (e.g., a UE served by the BS) can exchange signaling therewith. The descriptions regarding the expiry time of the source cell and the expiry time of the target cell in the preceding text may apply here.

For example, the expiry time may be determined based on at least one of the following:
a stop serving time of the cell (e.g., broadcast in the cell system information) minus N1 times of a propagation delay (e.g., RTT) between the UE and the BS, wherein N1 may be 0 or a positive integer such as 1 or 2;
the stop serving time of the cell minus N2 times of a reference propagation delay of the cell (e.g., a reference RTT such as an average RTT or a minimum RTT in the cell), wherein N2 may be 0 or a positive integer such as 1 or 2;
the time when the elevation angle between a RAN node which generates the cell (e.g., an antenna unit of the BS or the main or full units of the BS, such as satellite 102 in FIG. 1) and the UE becomes lower than an elevation angle threshold (e.g., a minimum elevation angle), minus N3 times of the propagation delay between the UE and the BS or the reference propagation delay of the cell, wherein N3 may be 0 or a positive integer such as 1 or 2; or
the time when the elevation angle between the RAN node and a cell reference location (e.g., the cell center) becomes lower than the elevation angle threshold, minus N4 times of the propagation delay between the UE and the BS or the reference propagation delay of the cell, wherein N4 may be 0 or a positive integer such as 1 or 2.

The expiry time may indicate at least one of: an absolute time (e.g., a UTC time); a remaining service time threshold; or a time duration from being configured.

In operation 213, the BS may transmit the expiry time to the UE. In some examples, the BS (e.g., source or target BS) may transmit broadcast information indicating the expiry time (e.g., broadcast in the system information).

In some examples, the source BS may determine the expiry time of the source cell. In some examples, the target BS may determine the expiry time of the target cell and may transmit it to the UE via the source BS. For example, the source BS may transmit a signaling message indicating the expiry time of the source cell, the expiry time of the target cell, or both to the UE. For example, the signaling message may include an RRC reconfiguration message. For example, the BS may transmit the expiry time with the DAPS handover configuration to the UE. In some examples, the target BS may transmit a signaling message (e.g., a container message such as a handover request acknowledgement message) indicating the expiry time of the target cell to the UE via the source BS.

In some embodiments, the BS may receive a reason for a DAPS handover failure from a UE served by the BS. The reason may include at least one of target cell movement or target cell expiry.

It should be appreciated by persons skilled in the art that the sequence of the operations in exemplary procedure 200 may be changed and some of the operations in exemplary procedure 200 may be eliminated or modified, without departing from the spirit and scope of the disclosure.

In some embodiments of the present disclosure, the expiry time for the source cell or the target cell (hereinafter, “an associated cell” for clarity) may be determined by a UE. For example, the expiry time may be determined based on at least one of the following:
a stop serving time of the associated cell (e.g., broadcast in the cell system information) minus N5 times of a propagation delay (e.g., RTT) between the UE and the corresponding BS (e.g., source or target BS), wherein N5 may be 0 or a positive integer such as 1 or 2; or
a time when the elevation angle between a RAN node which generates the associated cell and the UE becomes lower than an elevation angle threshold (e.g., a minimum elevation angle), minus N6 times of the propagation delay between the UE and the corresponding BS, wherein N6 may be 0 or a positive integer such as 1 or 2.

The expiry time may indicate at least one of: an absolute time (e.g., a UTC time); a remaining service time threshold; or a time duration from being determined.

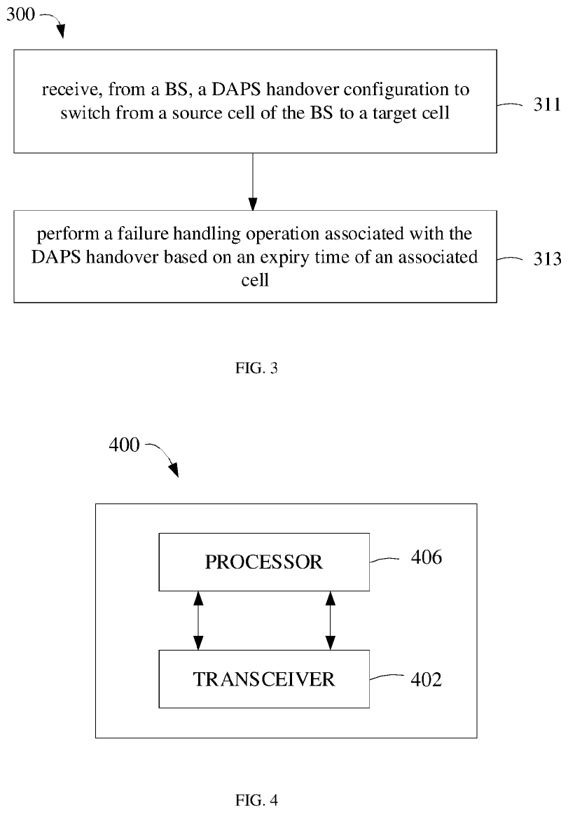

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a UE, for example, UE 101 in FIG. 1.

Referring to FIG. 3, in operation 311, a UE may receive, from a BS (source BS), a DAPS handover configuration to switch from a source cell of the BS to a target cell. The target cell may belong to a different BS or also belong to the source BS.

In operation 313, the UE may perform a failure handling operation associated with the DAPS handover based on an expiry time of an associated cell. The associated cell may be the source cell or the target cell. The expiry time of the associated cell may include at least one of a first expiry time of the source cell or a second expiry time of the target cell. The descriptions regarding the expiry time of the source cell and the expiry time of the target cell in the preceding text may apply here.

The failure handling operation described in in the preceding text may apply here. For example, in some embodiments of the present disclosure, the failure handling operation may include at least one of the following:
terminating data transmission, data reception, signaling transmission, signaling reception, or any combination thereof in the source cell;
discarding the RRC configuration in the source cell;
discarding the RRC configuration in the target cell;
releasing a connection to the source cell;
terminating a random access to the target cell;
declaring handover failure;
declaring an RLF in the source cell;
declaring an RLF in the target cell;
precluding the source cell in search of a suitable cell after the DAPS handover failure;
precluding the source cell in cell selection or reselection when the UE is in an idle state after the DAPS handover failure;
precluding the target cell in search of a suitable cell after the DAPS handover failure;
precluding the target cell in cell selection or reselection when the UE is in an idle state after the DAPS handover failure;
storing the reason for the DAPS handover failure; or.
reporting the reason for the DAPS handover failure to the network.

For example, in response to the first expiry time of the source cell being reached during the DAPS handover, the UE may perform at least one of the following:
terminating data transmission, signaling transmission, data reception, and signaling reception, or any combination thereof on the source link in the source cell;
discarding the RRC configuration associated with the source cell;
releasing the source link to the source BS in the source cell;
declaring a RLF in the source cell;
skipping any resume or reestablishment to the source cell in the case that the DAPS handover failure or an RLF occurs in the target cell;
precluding the source cell in search of a suitable cell in the case that the DAPS handover failure or an RLF failure occurs in the target cell; or.
precluding the source cell in a cell selection or cell reselection when the UE is in an idle state in the case that the DAPS handover failure or an RLF failure occurs in the target cell.

For example, in response to the second expiry time of the target cell being reached during the DAPS handover, the UE may perform at least one of the following:
terminating data transmission, signaling transmission, data reception, and signaling reception, or any combination thereof in the target cell;
discarding an RRC configuration associated with the target cell;
terminating a random access to the target cell;
considering the DAPS handover as failed;
declaring a DAPS handover failure;
declaring an RLF in the target cell;
precluding the target cell in search of a suitable cell in the case that an RLF or a connection release occurs in the source cell or in response to the DAPS handover failure;
precluding the target cell in a cell selection or cell reselection when the UE is in an idle state in the case that an RLF or a connection release occurs in the source cell or in response to the DAPS handover failure;
storing a reason for the DAPS handover failure in response to the DAPS handover failure;
reporting a reason for the DAPS handover failure to the source cell in response to the DAPS handover failure and a connection established to the source cell (e.g., the RRC connection to the source cell is resumed or reestablished); or
reporting a reason for the DAPS handover failure to another cell in response to the DAPS handover failure and a connection established to this cell.

In some embodiments, the reason for the DAPS handover failure may be reported in an immediate MDT report or a logged MDT report. In some embodiments, the reason for the DAPS handover failure may include at least one of target cell movement or target cell expiry.

In some embodiments, the expiry time of the associated cell may indicate at least one of: an absolute time; a remaining service time threshold; or a time duration. In some embodiments, the UE may start a timer based on the time duration in response to the UE determining the time duration or receiving the time duration.

As described above, the expiry time of the associated cell may be determined by the UE or may be configured by a BS.

For example, the UE may receive the expiry time of the associated cell. In some embodiments, receiving the expiry time of the associated cell may include at least one of: receiving broadcast information indicating the first expiry time in the source cell; receiving broadcast information indicating the second expiry time in the target cell; receiving a signaling message (e.g., an RRC reconfiguration message) indicating the expiry time of the associated cell from the first BS; or receiving a signaling message (e.g., a container message) indicating the second expiry time of the target cell from a target BS that the target cell belongs to via the first BS.

In some embodiments, the expiry time of the associated cell may be based on at least one of: a serving time of the associated cell; a propagation delay between the UE and a BS (e.g., the source BS or the target BS) that the associated cell belongs to; or a reference propagation delay in the associated cell (e.g., the source cell or the target cell).

For example, the UE may determine the expiry time of the associated cell according to the methods as described above. In some embodiments, the expiry time of the associated cell may be based on at least one of: a serving time of the associated cell (e.g., the source cell or the target cell); a propagation delay between the UE and a BS (e.g., the source BS or the target BS) that the associated cell belongs to; or a time when the UE determines the expiry time of the associated cell.

In some embodiments, the serving time of the associated cell may include at least one of: a stop serving time of the associated cell (e.g., t-Service); a time when an elevation angle between a RAN node that generates the associated cell and the UE is smaller than or equal to lower than an elevation angle threshold; or a time when an elevation angle between the RAN node and a reference location of the associated cell is smaller than or equal to the elevation angle threshold.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a block diagram of an exemplary apparatus 400 according to some embodiments of the present disclosure. As shown in FIG. 4, the apparatus 400 may include at least one processor 406 and at least one transceiver 402 coupled to the processor 406. The apparatus 400 may be a UE or a BS.

Although in this figure, elements such as the at least one transceiver 402 and processor 406 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

In some embodiments of the present application, the apparatus 400 may be a UE. The transceiver 402 and the processor 406 may interact with each other so as to perform the operations with respect to the UE described in FIGS. 1-3. In some embodiments of the present application, the apparatus 400 may be a BS. The transceiver 402 and the processor 406 may interact with each other so as to perform the operations with respect to the BS described in FIGS. 1-3.

In some embodiments of the present application, the apparatus 400 may further include at least one non-transitory computer-readable medium.

For example, in some embodiments of the present disclosure, the non-transitory computer-readable medium may have stored thereon computer-executable instructions to cause the processor 406 to implement the method with respect to the UE as described above. For example, the computer-executable instructions, when executed, cause the processor 406 interacting with transceiver 402 to perform the operations with respect to the UE described in FIGS. 1-3.

In some embodiments of the present disclosure, the non-transitory computer-readable medium may have stored thereon computer-executable instructions to cause the processor 406 to implement the method with respect to the BS as described above. For example, the computer-executable instructions, when executed, cause the processor 406 interacting with transceiver 402 to perform the operations with respect to the BS described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a first base station, a dual active protocol stack (DAPS) handover configuration to switch from a source cell of the first base station to a target cell; and
perform a failure handling operation associated with the DAPS handover based on an expiry time of an associated cell,
wherein the expiry time of the associated cell includes at least one of a first expiry time of the source cell or a second expiry time of the target cell.

2. The UE of claim 1, wherein performing the failure handling operation includes at least one of:
in response to the first expiry time of the source cell being reached during the DAPS handover, performing at least one of the following:
terminating data transmission, signaling transmission, data reception, and signaling reception in the source cell;
discarding a radio resource control (RRC) configuration associated with the source cell;
releasing a connection to the source cell;
declaring a radio link failure (RLF) in the source cell;
precluding the source cell in search of a suitable cell in response to a DAPS handover failure or an RLF failure in the target cell; or
precluding the source cell in a cell selection or cell reselection when the UE is in an idle state in response to a DAPS handover failure or an RLF failure in the target cell; or
in response to the second expiry time of the target cell being reached during the DAPS handover, performing at least one of the following:
terminating data transmission, signaling transmission, data reception, and signaling reception in the target cell;
discarding an RRC configuration associated with the target cell;
terminating a random access to the target cell;
declaring a DAPS handover failure;
declaring an RLF in the target cell;
precluding the target cell in search of a suitable cell in response to an RLF or a connection release in the source cell or in response to a DAPS handover failure;
precluding the target cell in a cell selection or cell reselection when the UE is in an idle state in response to an RLF or a connection release in the source cell or in response to a DAPS handover failure;
storing a reason for a DAPS handover failure in response to the DAPS handover failure;
reporting a reason for a DAPS handover failure to the source cell in response to the DAPS handover failure and a connection established to the source cell; or
reporting a reason for a DAPS handover failure to another cell in response to the DAPS handover failure and a connection established to the another cell.

3. The UE of claim 2, wherein the reason for a DAPS handover failure includes at least one of target cell movement or target cell expiry.

4. The UE of claim 1, wherein the expiry time of the associated cell indicates at least one of: an absolute time; a remaining service time threshold; or a time duration.

5. The UE of claim 4, wherein the at least one processor is configured to cause the UE to start a timer based on the time duration in response to the UE determining the time duration or receiving the time duration.

6. The UE of claim 1, wherein the at least one processor is configured to cause the UE to receive the expiry time of the associated cell.

7. The UE of claim 6, wherein receiving the expiry time of the associated cell comprises at least one of:
receiving broadcast information indicating the first expiry time in the source cell;
receiving broadcast information indicating the second expiry time in the target cell;
receiving a signaling message indicating the expiry time of the associated cell from the first base station; or
receiving a signaling message indicating the second expiry time of the target cell from a second base station that the target cell belongs to via the first base station.

8. The UE of claim 6, wherein the expiry time of the associated cell is based on at least one of:
a serving time of the associated cell;
a propagation delay between the UE and a base station that the associated cell belongs to; or
a reference propagation delay in the associated cell.

9. The UE of claim 1, wherein the at least one processor is configured to cause the UE to determine the expiry time of the associated cell.

10. The UE of claim 9, wherein the expiry time of the associated cell is based on at least one of:
a serving time of the associated cell;
a propagation delay between the UE and the base station that the associated cell belongs to; or
a time when the UE determines the expiry time of the associated cell.

11. The UE of claim 10, wherein the serving time of the associated cell comprises at least one of:
a stop serving time of the associated cell;
a time when an elevation angle between a radio access network (RAN) node that generates the associated cell and the UE is smaller than or equal to lower than an elevation angle threshold; or
a time when an elevation angle between the RAN node and a reference location of the associated cell is smaller than or equal to the elevation angle threshold.

12. A base station, comprising:
at least one memory; and
at least one processor coupled with the at least one memory and configured to cause the base station to:
determine an expiry time of a cell, wherein the cell is a source cell or a target cell for a dual active protocol stack (DAPS) handover; and
transmit the expiry time to a user equipment (UE).

13. The base station of claim 12, wherein the expiry time indicates at least one of: an absolute time; a remaining service time threshold; or a time duration.

14. The base station of claim 12, wherein the expiry time is determined based on at least one of:
a serving time of the cell;
a propagation delay between the UE and the base station that the cell belongs to; or
a reference propagation delay in the cell.

15. A method performed by a user equipment (UE), the method comprising:
receiving, from a first base station, a dual active protocol stack (DAPS) handover configuration to switch from a source cell of the first base station to a target cell; and
performing a failure handling operation associated with the DAPS handover based on an expiry time of an associated cell,
wherein the expiry time of the associated cell includes at least one of a first expiry time of the source cell or a second expiry time of the target cell.

16. A processor for wireless communication, comprising:
at least one controller coupled with at least one memory and configured to cause the processor to:
receive, from a first base station, a dual active protocol stack (DAPS) handover configuration to switch from a source cell of the first base station to a target cell; and
perform a failure handling operation associated with the DAPS handover based on an expiry time of an associated cell,
wherein the expiry time of the associated cell includes at least one of a first expiry time of the source cell or a second expiry time of the target cell.

17. The processor of claim 16, wherein performing the failure handling operation includes at least one of:
in response to the first expiry time of the source cell being reached during the DAPS handover, performing at least one of the following:
terminating data transmission, signaling transmission, data reception, and signaling reception in the source cell;
discarding a radio resource control (RRC) configuration associated with the source cell;
releasing a connection to the source cell;
declaring a radio link failure (RLF) in the source cell;
precluding the source cell in search of a suitable cell in response to a DAPS handover failure or an RLF failure in the target cell; or
precluding the source cell in a cell selection or cell reselection when a user equipment (UE) is in an idle state in response to a DAPS handover failure or an RLF failure in the target cell; or
in response to the second expiry time of the target cell being reached during the DAPS handover, performing at least one of the following:
terminating data transmission, signaling transmission, data reception, and signaling reception in the target cell;
discarding an RRC configuration associated with the target cell;
terminating a random access to the target cell;
declaring a DAPS handover failure;
declaring an RLF in the target cell;
precluding the target cell in search of a suitable cell in response to an RLF or a connection release in the source cell or in response to a DAPS handover failure;
precluding the target cell in a cell selection or cell reselection when the UE is in an idle state in response to an RLF or a connection release in the source cell or in response to a DAPS handover failure;
storing a reason for a DAPS handover failure in response to the DAPS handover failure;
reporting a reason for a DAPS handover failure to the source cell in response to the DAPS handover failure and a connection established to the source cell; or
reporting a reason for a DAPS handover failure to another cell in response to the DAPS handover failure and a connection established to the another cell.

18. The processor of claim 17, wherein the reason for a DAPS handover failure includes at least one of target cell movement or target cell expiry.

19. The processor of claim 16, wherein the expiry time of the associated cell indicates at least one of: an absolute time; a remaining service time threshold; or a time duration.

20. The processor of claim 19, wherein the at least one controller is configured to cause the processor to start a timer based on the time duration in response to the processor determining the time duration or receiving the time duration.
